(19) United States
(12) Patent Application Publication
(10) Pub. No.: US 2017/0047586 A1
(43) Pub. Date: Feb. 16, 2017

(54) ELECTROCHEMICAL CELLS EXPOSED TO HYDROSTATIC PRESSURE

(71) Applicant: BASF SE, Ludwigshafen (DE)

(72) Inventors: Joern KULISCH, Eppelheim (DE); Marina SAFONT SEMPERE, Ludwigshafen (DE); Lkaus LEITNER, Ludwigshafen (DE); Holger SCHNEIDER, Tucson, AZ (US); Thomas WEISS, Ilvesheim (DE)

(73) Assignee: BASF SE, Ludwigshafen (DE)

(21) Appl. No.: 15/304,341

(22) PCT Filed: Apr. 2, 2015
(86) PCT No.: PCT/EP2015/057312

§ 371 Date: Oct. 14, 2016

Related U.S. Application Data
(60) Provisional application No. 61/980,074, filed on Apr. 16, 2014.

(51) Int. Cl. H01M 4/38; H01M 4/36; H01M 4/60; H02J 7/00; H01M 10/0569; H01M 10/0568; H01M 10/0525; H01M 2/10; H01M 2/02

(52) U.S. Cl. CPC H01M 4/38; H01M 2/1094; H01M 4/364; H01M 4/602; H01M 2/0275; H01M 10/0569; H01M 10/0568; H01M 10/0525; H02J 7/0068; H01M 2004/028

(57) ABSTRACT

The present invention relates to a battery comprising as a first component (A) a pressure vessel (A) and as a second component (B), which is inside of the pressure vessel (A), at least one electrochemical cell (B) comprising at least one cathode comprising at least one electroactive sulfur-containing material, wherein the pressure vessel (A) can be filled or is filled with a pressure medium (C) in order to generate a pressure in the range from 2 bar to 200 bar inside of said pressure vessel. The present invention further relates to a process for operating an electrochemical cell (B), wherein the electrochemical cell (B) is exposed to a hydrostatic pressure in the range from 2 bar to 200 bar.

The present invention relates to a battery comprising as a first component (A) a pressure vessel (A) and as a second component (B), which is inside of the pressure vessel (A), at least one electrochemical cell (B) comprising at least one cathode comprising at least one electroactive sulfur-containing material, wherein the pressure vessel (A) can be filled or is filled with a pressure medium (C) in order to generate a pressure in the range from 2 bar to 200 bar inside of said pressure vessel.

The present invention further relates to a process for operating an electrochemical cell (B), wherein the electrochemical cell (B) is exposed to a hydrostatic pressure in the range from 2 bar to 200 bar.

Secondary batteries, accumulators or “rechargeable batteries” are just some embodiments by which electrical energy can be stored after generation and used when required. Owing to the significantly better power density, there has in recent times been a move away from the water-based secondary batteries toward development of those batteries in which the charge transport in the electrical cell is accomplished by lithium ions.

However, the specific energy of conventional lithium ion accumulators which have a carbon anode and a cathode based on metal oxides is limited. New dimensions in respect of the specific energy have been opened up by lithium-sulfur cells. Ideally, in lithium-sulfur cells, sulfur (S₈) is reduced in the sulfur cathode via polysulfide ions to S²⁻ (i.e. Li₂S), which on charging of the cell is reoxidized to form sulfur-sulfur bonds.

Unfortunately rechargeable lithium-sulfur cells are still not technically mature. Compared with commercially available lithium ion batteries the investigated lithium-sulfur cells show a stronger capacity fading usually followed by a sudden cell failure. With respect to these observations several failure mechanisms are discussed that might even be synergistic.

The following theories, working hypotheses and explanations are discussed in the literature:

In lithium sulfur cells the metallic lithium of the anode is stripped and plated in every charge and discharge. The main failure mechanism of these cells is the reaction of the metallic lithium anode with the electrolyte which results in drying of the cell and therefore fast capacity fading and fatal failure of the electrochemical system. While cycling lithium dendritic growth happens on the lithium surface. This results in high surface area lithium which increases the reactivity of the lithium causing the electrolyte to react and be consumed even faster. In addition, some of the depletion products from the lithium reaction with the electrolyte are gases (ethylene, acetylene, nitrous gases, nitrogen, hydrogen . . . ). The generation of gas results in local inhomogeneities in the current distribution affecting the long-term stability of the cell.

The standard cathode in lithium sulfur cells is composed of carbon, elemental sulfur and a binder. Upon discharging the elemental sulfur is reduced to polysulfides that are dissolved in the electrolyte. This process affects the mechanical stability of the cathode since the cavities in which the sulfur was present as solid are filled now with electrolyte and not with sulfur which causes partial collapse of the cathode.

Thus, dendritic growth of lithium, mechanical stability of the cathode and the gaseous products from the reaction of the electrolyte with lithium metal are the main causes of the failure of lithium sulfur cells and must be addressed.

The dendritic growth of lithium is currently addressed by the application of uniaxial pressure perpendicular to the electrode planes. The application of uniaxial pressure reduces dendritic growth of lithium resulting in a more homogeneous lithium surface and therefore lowering the reaction of the electrolyte with metallic lithium and improving the performance of the cell. However, by the application of uniaxial pressure the mechanical stability of the cathode is compromised since the mentioned collapse of the structure is more prominent.

One problem is the solubility of the polysulfides, for example Li₂S₄ and Li₂S₆, which are soluble in the solvent/electrolyte and can migrate to the anode. The consequences may include a loss of (capacitance) active material. The migration of the polysulfide ions from the cathode to the anode can ultimately lead to self-discharge of the affected cell. This unwanted migration of polysulfide ions is also referred to as “shuttling”/“polysulfide shuttle”, a term which is also used in the context of the present invention.

U.S. Pat. No. 6,007,935 describes a rechargeable generator consisting of an anode of an alkali metal or a malleable alkali alloy, at least one polymer electrolyte which is conductive with respect to alkali cations and acts as separator, as well as at least one cathode which is reversible to cations of alkali metal and its current collector wherein the combination of anode, electrolyte, cathode and collector is maintained under a mechanical strain which is sufficient to ensure that the separator confines the anode sheet in place to preserve the integrity of the lithium-electrolyte interface during consecutive cycles of dissolution/plating.

US 2010035128 describes the application of a force to enhance the performance of an electrochemical cell. When an anisotropic force with a component normal to an active surface of the anode of the electrochemical cell is applied, an even deposition of lithium metal on the anode during charging resulting in a smooth surface of lithium metal has been observed.

US 2010159306 proposes a device having at least one electrochemical cell, characterized by a volume for receiving the at least one cell, the volume being capable of being subjected to pressure by a pressure medium, for subjecting at least one cell to external pressure.

U.S. Pat. No. 8,178,228 describes an all-solid-state battery capable of improving output power. The all-solid-state battery includes a wound solid electrolyte/electrode assembly and a case housing the solid electrolyte/electrode assembly with a pressurized fluid being filled between the inner periphery surface of the case and the solid electrolyte/electrode assembly.

Lithium-sulfur cells and batteries comprising lithium-sulfur cells, which are described in the literature, still have the above mentioned shortcomings.

It was therefore an object of the invention to provide batteries comprising electrochemical cells, in particular lithium-sulfur cells, which have advantages over one or more properties of the lithium-sulfur batteries known in the state of the art, in particular with respect to an increase of energy density of the electrochemical cell by reducing the amount of electrolyte, to an increase of cycle life and of coulombic efficiency reflected by improved cycling stability and reduction of capacity fading. In general, the desired properties mentioned also make a crucial contribution to improving the economic viability of the lithium-sulfur battery, which, as well as the aspect of the desired technical performance profile of the lithium-sulfur battery, is of crucial significance to the user.

This object is achieved by a battery comprising

(A) a pressure vessel (A), and
(B) inside of the pressure vessel (A) at least one electrochemical cell (B), comprising
(B1) an assembly (B1), comprising
   (B1-a) at least one cathode (B1-a) comprising at least one electroactive sulfur-containing material,
   (B1-b) at least one anode (B1-b), (B1-c) at least one separator (B1-c), and
   (B1-d) at least one electrolyte composition (B1-d) comprising
      (B1-d1) at least one solvent (B1-d1), and
      (B1-d2) at least one alkali metal salt (B1-d2), and
(B2) optionally a case (B2) housing the assembly (B1),
   wherein the pressure vessel (A) can be filled or is filled with a pressure medium (C) in order to generate a pressure in the range from 2 bar to 200 bar, preferably in the range from 2 bar to 100 bar, more preferably in the range from 3 bar to 40 bar, inside of said pressure vessel, preferably wherein the pressure vessel (A) is filled with a pressure medium (C) and the pressure inside of said pressure vessel is in the range from 2 bar to 200 bar, preferably in the range from 2 bar to 100 bar, more preferably in the range from 3 bar to 40 bar.

In the context with the present invention, the electrode where during discharging a net negative charge occurs is called the anode and the electrode where during discharging a net positive charge occurs is called the cathode.

The inventive battery comprises as a first component (A) a pressure vessel (A), also referred to hereinafter as vessel (A), and as a second component (B), which is inside of said vessel (A), at least one electrochemical cell (B), in particular a rechargeable electrochemical cell (B), also referred to hereinafter as cell (B), which comprises at least one cathode (B1-a) comprising at least one electroactive sulfur-containing material, wherein vessel (A) can be filled or is filled, preferably is filled, with a pressure medium (C), also referred to hereinafter as medium (C), in order to generate a pressure in the range from 2 bar to 200 bar inside of said pressure vessel.

Pressure vessels (A) as such are known to the person skilled in the art. A pressure vessel is usually defined as a closed container designed to hold gases or liquids at a pressure substantially different from the ambient pressure. Preferred shapes, construction materials and the appropriate design are known to the respective person skilled in the art. In case of the present invention vessel (A) is constructed in such a manner that it withstands at least an internal pressure that is in the range from 2 bar to 200 bar. Preferably vessel (A) withstands at most a pressure, that is at least 50%, preferably at least 100% higher than the applied internal pressure, which is in the range from 2 bar to 200 bar, preferably in the range from 2 bar to 100 bar, more preferably in the range from 3 bar to 40 bar.

In the context with the present invention, the pressure inside of said pressure vessel (A) is also called internal pressure. While the pressure outside of vessel (A) is usually atmospheric pressure in the range from 0.5 to 1.06 bar depending on the weather and the altitude above the sea level, the pressure inside of said pressure vessel (A) is higher than the atmospheric pressure, preferably in the range from 2 bar to 200 bar, preferably in the range from 2 bar to 100 bar, more preferably in the range from 3 bar to 40 bar.

Vessel (A) comprises or at least comprised an opening in order to be able to introduce cell (B) into vessel (A) and eventually to remove cell (B) for maintenance or recycling. Said opening can either be reversibly closed by a pressure vessel closure or the opening is irreversibly closed after insertion of cell(s) (B), e. g. by welding an adapted lid to the vessel.

Beside the opening for inserting cell (B) vessel (A) comprises or comprised, preferably comprises an inlet and an outlet, through which pressure medium (C) can be filled into said pressure vessel (A) or drained off. The inlet and outlet of vessel (A) can be realized by two different openings or can be realized by a single opening preferably in each case equipped with an appropriate valve or cook. Alternatively the inlet and outlet can irreversibly be sealed after introducing pressure medium (C).

In one embodiment of the present invention, the inventive battery is characterized in that pressure vessel (A) comprises or comprised, preferably comprises an inlet and an outlet, through which pressure medium (C) can be filled into said pressure vessel (A) or drained off.

Vessel (A) further has an electrical connection in order to be able to connect cell(s) (B) with an electrical load or a measuring instrument outside of said vessel (A).

In one embodiment of the present invention, the inventive battery is characterized in that pressure vessel (A) has an electrical connection.

Pressure medium (C) is filled into vessel (A) in order to generate an internal pressure. In principle medium (C) can be chosen from a wide range of compounds as far as medium (C) is capable to flow. Medium (C) is preferably a gaseous or liquid compound at a temperature where medium (C) is handled or where the inventive battery is operated. Since medium (C) surrounds cell (B) and also cable connections and since shorts have to be avoided medium (C) is more preferably a gaseous or liquid, electrically non-conducting compound, preferably selected from organic or inorganic solvents, electrolyte compositions, preferably electrolyte composition (B1-d), gases and mixtures of gases.

In one embodiment of the present invention, the inventive battery is characterized in that the pressure medium (C) is a gaseous or liquid, electrically non-conducting compound, preferably selected from organic or inorganic solvents, electrolyte compositions, preferably electrolyte composition (B1-d), gases and mixtures of gases.

Examples of suitable electrically non-conducting liquids beside electrolyte compositions (B1-d) are mineral oils, silicon-based oils, fluorinated hydrocarbons, vegetable-based oils, polychlorinated biphenyls, esters, glycerin or glycols.

Examples of suitable electrically non-conducting gases are inert gases like He, Ne, Ar, Kr or Xe, reactive gases like N₂O, NO₂, O₂, H₂, SO₂, N₂, SF₆ or CO₂, or fluorinated hydrocarbons with a boiling point below 20° C., like tetrafluoromethane, difluoromethane, hexafluoroethane, 1,1,1,2-tetrafluoroethane, fluoroethane or octafluoropropane.

In case that cell (B) does not comprise a case (B2) at all or cell (B) does comprise a case (B2), which does not hermetically house assembly (B1), medium (C) is in direct contract with electrolyte composition (B1-d). In that case medium (C) is preferably selected from electrolyte compositions (B1-d), liquids almost immiscible with electrolyte composition (B1-d), gases and mixtures of gases, in particular gases and mixtures of gases.

If electrolyte composition (B1-d) is also used as medium (C), the total mass of all electrolyte compositions (B1-d) originating from the preparation of cell (B) and originating from the introduction of medium (C) into vessel (A) is preferably equivalent to the mass of all electrolyte compositions (B1-d) necessary to fill all voids or empty space of all assemblies (B1), which have been placed in vessel (A).

In order provide an electrochemical cell (B) with a high energy density the assembly (B1) is preferably arranged in such a way that it fills the volume of cell (B) in the range from 80% to 100%, more preferably in the range from 90% to 100%, in particular in the range from 95% to 100%. In case that assembly (B1) is housed in a case (B2) a high energy density of electrochemical cell (B) is preferably achieved by tightly surrounding assembly (B1) with case (B2). In the absence of a case (B2) assembly (B1) is preferably tightly surrounded by vessel (A).

A typical arrangement of an electrochemical cell with a high energy density is for example a pouch cell, wherein assembly (B1) is tightly surrounded by a sealed, flexible, foil-type (polymer laminate) case. So called pouch cells are usually designed in prismatic shape. Another typical arrangement of an electrochemical cell with a high energy density is a cylindrical cell, wherein a roll of assembly (B1) is mounted into vessel (A), e. g. into a rigid metal case such as a steal autoclave or an adapted gas cylinder.

In one embodiment of the present invention, the inventive battery is characterized in that pressure vessel (A) and/or case (B2) tightly surround assembly (B1).

An additional effect of the tightly surrounding of assembly (B1) is the generation of an anisotropic compression with a component normal to the solid components of assembly (B1) resulting in a smoother lithium metal deposition during charging of cell (B).

In one embodiment of the present invention, the inventive battery is characterized in that cell (B) comprises a case (B2) housing the assembly (B1).

Case (B2) can be made of a variety of materials. Preferably case (B2) is made of a flexible material, such a laminated foil, e. g. a metallized polymer foil. Case (B2) can either hermetically seal assembly (B1) from medium (C) or case (B2) comprises at least one opening allowing the admission of medium (C) to assembly (B1). Preferably case (B2) is sealed in order to prevent any contact of medium (C) with the components of assembly (B1).

In one embodiment of the present invention, the inventive battery is characterized in that case (B2) is made of a flexible material.

In another embodiment of the present invention, the inventive battery is characterized in that case (B2) is sealed, in particular in order to prevent any exchange of material between pressure medium (C) and any component of assembly (B1).

In a preferred embodiment of the present invention, the inventive battery is characterized in that cell (B) comprises a case (B2) housing the assembly (B1) and tightly surrounding assembly (B1), wherein case (B2) is made of a flexible material and is sealed.

The electrochemical cell (B), which is in particular a rechargeable electrochemical cell (B), comprises an assembly (B1), which comprises as a first component (B1-a) at least one cathode (B1-a) comprising at least one electroactive sulfur-containing material, as a second component (B1-b) at least one anode (B1-b), as a third component (B1-c) at least one separator (B1-c), and as a fourth component (B1-d) at least one electrolyte composition (B1-d) comprising at least one solvent (B1-d1), and at least one alkali metal salt (B1-d2).

Assembly (B1) comprises at least one cathode (B1-a) comprising at least one electroactive sulfur-containing material. In the context of the present invention, this cathode (B1-a) comprising at least one electroactive sulfur-containing material is also called cathode (B1-a) for short.

Electroactive sulfur-containing materials are for example covalent compounds like elemental sulfur, composites produced from elemental sulfur and at least one polymer, composites produced from elemental sulfur and at least one carbon material or polymers comprising polysulfide bridges or ionic compounds like salts of sulfides or polysulfides.

Elemental sulfur is known as such.

Composites produced from elemental sulfur and at least one polymer, which find use as a constituent of electrode materials, are likewise known to those skilled in the art. Adv. Funct. Mater. 2003, 13, 487 if describes, for example, a reaction product of sulfur and polyacrylonitrile, which results from elimination of hydrogen from polyacrylonitrile with simultaneous formation of hydrogen sulfide.

Composites produced from elemental sulfur and at least one carbon material are described for example in US 2011/318654 or US 2012/298926.

Polymers comprising divalent di- or polysulfide bridges, for example polyethylene tetrasulfide, are likewise known in principle to those skilled in the art. J. Electrochem. Soc., 1991, 138, 1896-1901 and U.S. Pat. No. 5,162,175 describe the replacement of pure sulfur with polymers comprising disulfide bridges. Polyorganodisulfides are used therein as materials for solid redox polymerization electrodes in rechargeable cells, together with polymeric electrolytes.

Salts of sulfides or polysulfides are examples of ionic compounds comprising at least one Li—S— group like Li₂S, lithium polysulfides (Li₂S_{2 to 8}) or lithiated thiols (lithium thiolates).

A preferred electroactive sulfur-containing material is elemental sulfur.

In one embodiment of the present invention, the inventive battery is characterized in that the electroactive sulfur-containing material of cathode (B1-a) is elemental sulfur.

During the charging process of an inventive rechargeable electrochemical cell cathode (B1-a) comprises usually a mixture of different electroactive sulfur-containing materials since more and more S—S-bonds are formed.

Cathode (B1-a) may comprise one or further constituents. For example, cathode (B1-a) may comprise carbon in a conductive polymorph, for example selected from graphite, carbon black, carbon nanotubes, graphene or mixtures of at least two of the aforementioned substances. Suitable carbons in a conductive polymorph are described in WO 2012/168851 page 4, line 30 to page 6, line 22.

In one embodiment of the present invention, the inventive rechargeable electrochemical cell is characterized in that cathode (a) contains a material based on electrically conductive carbon.

In addition, cathode (B1-a) may comprise one or more binders, for example one or more organic polymers. Suitable binders are described in WO 2012/168851 page 6, line 40 to page 7, line 30.

Particularly suitable binders for the cathode (B1-a) are especially polyvinyl alcohol, poly(ethylene oxide), carboxymethyl cellulose (CMC) and halogenated (co)polymers, for example polyvinyl chloride or polyvinylidene chloride, especially fluorinated (co)polymers such as polyvinyl fluoride and especially polyvinylidene fluoride, lithiated Nafion and polytetrafluoroethylene, conductive polymers such as poly(thiophene).

In one embodiment of the present invention, cathode (B1-a) of the inventive cell comprises in the range from 10 to 90% by weight, preferably 50 to 70% by weight, of sulfur, determined by elemental analysis, based on the total mass of the sum of all electroactive sulfur-containing materials, all carbon in a conductive polymorph and all binders.

In one embodiment of the present invention, cathode (B1-a) of the inventive cell comprises in the range from 0.1 to 60% by weight of carbon in a conductive polymorph, preferably 1 to 45% by weight based on the total mass of the sum of all electroactive sulfur-containing materials, all carbon in a conductive polymorph and all binders. This carbon can likewise be determined by elemental analysis, for example, in which case the evaluation of the elemental analysis has to take into account the fact that carbon also arrives in organic polymers representing binders, and possibly further sources.

In one embodiment of the present invention, cathode (B1-a) of the inventive cell comprises in the range from 0.1 to 20% by weight of binder, preferably 1 to 15% by weight and more preferably 3 to 10% by weight, based on the total mass of the sum of all electroactive sulfur-containing materials, all carbon in a conductive polymorph and all binders.

In addition, cathode (B1-a) may have further constituents customary per se, for example an current collector, which may be configured in the form of a metal wire, metal grid, metal mesh, expanded metal, metal sheet, metal foil or carbon paper/cloth. Suitable metal foils are especially aluminum foils.

In one embodiment of the present invention, cathode (B1-a) has a thickness in the range from 25 to 200 μm, preferably from 30 to 100 μm, based on the thickness without current collector.

Assembly (B1) further comprises, as well as cathode (B1-a), at least one anode (B1-b). Preferably anode (B1-b) comprises at least one alkali metal like lithium or sodium or at least one earth alkali metal like magnesium, more preferably at least one alkali metal, in particular lithium.

The alkali metal of anode (B1-b) can be present in the form of a pure alkali metal phase, in form of an alloy together with other metals or metalloids, in form of an intercalation compound or in form of an ionic compound comprising at least one alkali metal and at least one transition metal.

Anode (B1-b) can be selected from anodes being based on various active materials. Suitable active materials are metallic lithium, carbon-containing materials such as graphite, graphene, charcoal, expanded graphite, in particular graphite, furthermore lithium titanate (Li₄Ti₅O₁₂), anodes comprising In, Tl, Sb, Sn or Si, in particular Sn or Si, for example tin oxide (SnO₂) or nano-crystalline silicon, and anodes comprising metallic lithium.

In one embodiment of the present invention, the inventive battery is characterized in that anode (B1-b) is selected from graphite anodes, lithium titanate anodes, anodes comprising In, Tl, Sb, Sn or Si, and anodes comprising metallic lithium.

In one embodiment of the present invention, the inventive battery is characterized in that anode (B1-b) comprises lithium, in particular metallic lithium.

Anode (B1-b) can further comprise a current collector. Suitable current collectors are, e.g., metal wires, metal grids, metal gauze and preferably metal foils such as copper foils.

Anode (B1-b) can further comprise a binder. Suitable binders can be selected from organic (co)polymers. Suitable organic (co)polymers may be halogenated or halogen-free. Examples are polyethylene oxide (PEO), cellulose, carboxymethyl cellulose, polyvinyl alcohol, polyethylene, polypropylene, polytetrafluoroethylene, polyacrylonitrile-methyl methacrylate, styrene-butadiene copolymers, tetrafluoroethylene-hexafluoropropylene copolymers, vinylidene fluoride-hexafluoropropylene copolymers (PVdF-HFP), vinylidene fluoride-tetrafluoroethylene copolymers, perfluoroalkyl vinyl ether copolymers, ethylene-tetrafluoroethylene copolymers, vinylidene fluoride-chlorotrifluoroethylene copolymers, ethylene-chlorofluoroethylene copolymers, ethylene-acrylic acid copolymers, optionally at least partially neutralized with alkali metal salt or ammonia, ethylene-methacrylic acid copolymers, optionally at least partially neutralized with alkali metal salt or ammonia, ethylene-(meth)acrylic ester copolymers, polysulfones, polyimides and polyisobutene.

Suitable binders are especially polyvinyl alcohol and halogenated (co)polymers, for example polyvinyl chloride or polyvinylidene chloride, especially fluorinated (co)polymers such as polyvinyl fluoride and especially polyvinylidene fluoride and polytetrafluoroethylene.

The average molecular weight M_{w} of binder may be selected within wide limits, suitable examples being 20,000 g/mol to 1,000,000 g/mol.

In one embodiment of the present invention, anode (B1-b) can have a thickness in the range of from 15 to 200 μm, preferably from 30 to 100 μm, determined without the current collector.

Assembly (B1) further comprises, as well as cathode (B1-a), and anode (B1-b), at least one separator (B1-c).

In one embodiment of the present invention, inventive electrochemical cells comprise one or more separators (B1-c) by which the electrodes are mechanically separated from one another. Suitable separators (B1-c) are polymer films, especially porous polymer films, which are unreactive toward metallic lithium and toward lithium sulfides and lithium polysulfides. Particularly suitable materials for separators (B1-c) are polyolefins, especially porous polyethylene films and porous polypropylene films.

Polyolefin separators (B1-c), especially of polyethylene or polypropylene, may have a porosity in the range from 35 to 45%. Suitable pore diameters are, for example, in the range from 30 to 500 nm.

In another embodiment of the present invention, the separators selected may be separators composed of PET nonwovens filled with inorganic particles. Such separators may have a porosity in the range from 40 to 55%. Suitable pore diameters are, for example, in the range from 80 to 750 nm.

Assembly (B1) further comprises, as well as cathode (B1-a), anode (B1-b) and separator (B1-c), at least one electrolyte composition (B1-d) comprising

(B1-d1) at least one solvent (B1-d1), and
(B1-d2) at least one alkali metal salt (B1-d2).

The least one electrolyte composition (B1-d) is usually a single homogeneous mixture, preferably a solution, which can be obtained by mixing two or more different electrolyte compositions, e.g. (B1-d′) and (B1-d″), together.

As regards suitable solvents and further additives for electrolyte compositions (B1-d), in particular nonaqueous liquid electrolytes for lithium-based rechargeable batteries reference is made to the relevant prior art, e.g. Chem. Rev. 2004, 104, 4303-4417, in particular table 1 on page 4307, table 2 on page 4308 and table 12 on page 4379.

Solvent (B1-d1) can be chosen from a wide range of solvents, in particular from solvents which dissolve alkali metal salts (B1-d2) easily. Solvents or solvent systems, which dissolve alkali metal salts (B1-d2) are for example ionic liquids, polar solvents or combinations of apolar solvents combined with polar additives like crown ethers, like 18-crown-6, or cryptands. Examples of polar solvents are polar protic solvents or dipolar aprotic solvents.

Examples of polar protic solvents are water, alcohols like methanol, ethanol or iso-propanol, carbonic acids like acetic acid, ammonia, primary amines or secondary amines. Polar protic solvents can only be used in electrochemical cell comprising an anode, which comprises an alkali metal, if any contact between that anode and the polar protic solvent is strictly precluded by an appropriate separator.

Examples of dipolar aprotic solvents are organic carbonates, esters, ethers, sulfones like DMSO, sulfamides, amides like DMF or DMAc, nitriles like acetonitril, lactams like NMP, lactones, linear or cyclic peralkylated urea derivatives like TMU or DMPU, fluorinated ether, fluorinated carbamates, fluorinated carbonated or fluorinated esters.

Possible solvents (B1-d2) may be liquid or solid at 40° C. and are preferably liquid at 40° C.

In one embodiment of the present invention the inventive battery is characterized in that the solvent (B1-d2) is a dipolar aprotic solvent.

Solvents (B1-d2) are preferably liquid at 40° C. and are selected from polymers, cyclic or noncyclic ethers, noncyclic or cyclic acetals, noncyclic or cyclic sulfones, noncyclic or cyclic sulfoamides and cyclic or noncyclic organic carbonates, preferably selected from cyclic or noncyclic ethers and noncyclic or cyclic acetals.

In one embodiment of the present invention the inventive battery is characterized in that solvent (B1-d1) is liquid at 40° C. and is selected from polymers, cyclic or noncyclic ethers, noncyclic or cyclic acetals, noncyclic or cyclic sulfones, noncyclic or cyclic sulfoamides and cyclic or noncyclic organic carbonates, preferably cyclic or noncyclic ethers and noncyclic or cyclic acetals.

Examples of suitable polymers are especially polyalkylene glycols, preferably poly-C₁-C₄-alkylene glycols and especially polyethylene glycols. Polyethylene glycols may comprise up to 20 mol % of one or more C₁-C₄-alkylene glycols in copolymerized form. Polyalkylene glycols are preferably doubly methyl- or ethyl-capped polyalkylene glycols.

The molecular weight M_{w} of suitable polyalkylene glycols and especially of suitable polyethylene glycols may be at least 400 g/mol.

The molecular weight M_{w} of suitable polyalkylene glycols and especially of suitable polyethylene glycols may be up to 5 000 000 g/mol, preferably up to 2 000 000 g/mol.

Examples of suitable noncyclic ethers are, for example, diisopropyl ether, di-n-butyl ether, 1,2-dimethoxyethane, 1,2-diethoxyethane, preference being given to 1,2-dimethoxyethane.

Examples of suitable cyclic ethers are tetrahydrofuran and 1,4-dioxane.

Examples of suitable noncyclic acetals are, for example, dimethoxymethane, diethoxymethane, 1,1-dimethoxyethane and 1,1-diethoxyethane.

Examples of suitable cyclic acetals are 1,3-dioxane and especially 1,3-dioxolane.

Examples of suitable noncyclic organic carbonates are dimethyl carbonate, ethyl methyl carbonate and diethyl carbonate.

Examples of suitable cyclic organic carbonates are compounds of the general formulae (X) and (XI)

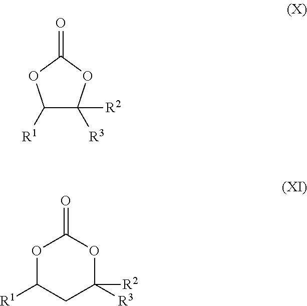

in which R¹, R² and R³ may be the same or different and are each selected from hydrogen and C₁-C₄-alkyl, for example methyl, ethyl, n-propyl, isopropyl, n-butyl, isobutyl, sec-butyl and tert-butyl, where R² and R³ are preferably not both tert-butyl.

In particularly preferred embodiments, R¹ is methyl and R² and R³ are each hydrogen, or R¹, R² and R³ are each hydrogen.

Another preferred cyclic organic carbonate is vinylene carbonate, formula (XII).

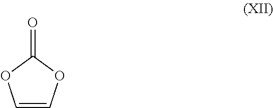

Preference is given to using the solvent(s) in what is called the anhydrous state, i.e. with a water content in the range from 1 ppm to 0.1% by weight, determinable, for example, by Karl Fischer titration.

Possible alkali metal salts (B1-d2), which are used as conductive salts, have to be soluble in the solvent (B1-d2). Preferred alkali metal salts (B1-d2) are lithium salts or sodium salts, in particular lithium salts.

In one embodiment of the present invention the inventive battery is characterized in that the alkali metal salt (B1-d2) is a lithium salt or sodium salt, preferably a lithium salt.

Suitable alkali metal salts are especially lithium salts. Examples of suitable lithium salts are LiPF₆, LiBF₄, LiB(C₂O₄)₂, LiI, LiClO₄, LiAsF₆, LiCF₃SO₃, LiC(CnF₂ₙ₊₁SO₂)₃, lithium imides such as LiN(CnF₂ₙ₊₁SO₂)₂, where n is an integer in the range from 1 to 20, LiN(SO₂F)₂, Li₂SiF₆, LiSbF₆, LiAlCl₄, and salts of the general formula (CₙF₂ₙ₊₁SO₂)ₘXLi, where m is defined as follows:

m=1 when X is selected from oxygen and sulfur,
m=2 when X is selected from nitrogen and phosphorus, and
m=3 when X is selected from carbon and silicon.

Preferred alkali metal salts are selected from LiC(CF₃SO₂)₃, LiN(CF₃SO₂)₂, LiPF₆, LiBF₄, LiB(C₂O₄)₂, LiI, LiNO₃, LiClO₄, and particular preference is given to LiPF₆ and LiN(CF₃SO₂)₂.

In one embodiment of the present invention, the concentration of conductive salt in electrolyte composition (B1-d) is in the range of from 0.01 M to 7 M, preferably 0.3 M to 1.5 M.

In one embodiment of the present invention, assembly (B1) can contain additives such as wetting agents, corrosion inhibitors, or protective agents such as agents to protect any of the electrodes or agents to protect the salt(s).

The inventive battery can be operated in a wide temperature range, preferably in a temperature range from −70° C. to 250° C., more preferably in a temperature range from −30° C. to 150° C.

The electrolyte composition (B1-d) or a mixture of electrolyte compositions (B1-d) of assembly (b1) is preferably a liquid in a temperature range from −70° C. to 250° C., more preferably in a temperature range from 30° C. to 150° C. The means that the melting point of electrolyte composition (B1-d) or a mixture of electrolyte compositions (B1-d) is preferably not above −70° C., more preferably not above −30° C. and the boiling point of electrolyte composition (B1-d) or mixture of electrolyte compositions (B1-d) is preferably above 250° C., more preferably above 150° C.

The mass ratio of the total mass of sulfur comprised in cathode (B1-a) to the total mass of electrolyte composition (B1-d) of assembly (B1) can be varied in wide range. The total mass of sulfur comprised in cathode (B1-a) can be determined by elemental analysis. Preferably the mass ratio of the total mass of sulfur comprised in cathode (B1-a) to the total mass of electrolyte composition (B1-d) of assembly (B1) is in the range from 0.05 to 1, more preferably in the range from 0.1 to 0.7, in particular in the range from 0.33 to 0.5.

In one embodiment of the present invention the inventive battery is characterized in that the mass ratio of the total mass of sulfur comprised in cathode (B1-a) to the total mass of electrolyte composition (B1-d) of assembly (B1) is in the range from 0.05 to 1, preferably 0.1 to 0.7, in particular 0.33 to 0.5.

In one embodiment of the present invention the inventive battery is characterized in that case (B2) is sealed and is made of a flexible material tightly surrounding assembly (B1), the electroactive sulfur-containing material of cathode (B1-a) is elemental sulfur, anode (B1-b) comprises lithium, the mass ratio of the total mass of sulfur comprised in cathode (B1-a) to the total mass of electrolyte composition (B1-d) of assembly (B1) is in the range from 0.05 to 1, preferably 0.1 to 07, in particular from 0.33 to 0.5, and the pressure vessel (A) is filled with a pressure medium (C) and the pressure inside of said pressure vessel is in the range from 2 bar to 20 bar.

In another embodiment of the present invention the inventive battery is characterized in that a roll of assembly (B1) is mounted into a cylindrical vessel (A), which tightly surrounds assembly (B1), the electroactive sulfur-containing material of cathode (B1-a) is elemental sulfur, anode (B1-b) comprises lithium, the mass ratio of the total mass of sulfur comprised in cathode (B1-a) to the total mass of electrolyte composition (B1-d) of assembly (B1) is in the range from 0.05 to 1, preferably 0.1 to 07, in particular from 0.33 to 0.5, and the pressure inside of vessel (A) is in the range from 2 bar to 20 bar.

Inventive batteries, in particular rechargeable lithium sulfur batteries, have advantageous properties. They exhibit good capacity, a low capacity fade rate per cycle, high coulombic efficiency and good cycling stability on extended cycling.

The inventive batteries can be used for making or operating cars, computers, personal digital assistants, mobile telephones, watches, camcorders, digital cameras, thermometers, calculators, laptop BIOS, communication equipment or remote car locks, and stationary applications such as energy storage devices for power plants. A further aspect of the present invention is a method of making or operating cars, computers, personal digital assistants, mobile telephones, watches, camcorders, digital cameras, thermometers, calculators, laptop BIOS, communication equipment, remote car locks, and stationary applications such as energy storage devices for power plants by employing at least one inventive battery.

The present invention further provides a device comprising at least one inventive battery as described above. Preferred are mobile devices such as are vehicles, for example automobiles, bicycles, aircraft, or water vehicles such as boats or ships. Other examples of mobile devices are those which are portable, for example computers, especially laptops, telephones or electrical power tools, for example from the construction sector, especially drills, battery-driven screwdrivers or battery-driven tackers.

The present invention further provides a process for operating an electrochemical cell (B), comprising

(B1) an assembly (B1), comprising
(B1-a) at least one cathode (B1-a) comprising at least one electroactive sulfur-containing material,
(B1-b) at least one anode (B1-b), preferably at least on anode (B1-b) comprising at least one alkali metal or earth alkali metal, more preferably comprising at least one alkali metal, in particular lithium,
(B1-c) at least one separator (B1-c), and
(B1-d) at least one electrolyte composition (B1-d) comprising
   (B1-d1) at least one solvent (B1-d1), and
   (B1-d2) at least one alkali metal salt (B1-d2), and
      (B2) optionally a case (B2) housing the assembly (B1),
      wherein the electrochemical cell (B) is exposed to a hydrostatic pressure in the range from 2 bar to 200 bar, preferably in the range from 2 bar to 100 bar, in particular in the range from 3 bar to 40 bar.

Preferred embodiments with regard to cathode (B1-a) and the constituents beside the electroactive sulfur-containing material present therein, namely carbon in a conductive polymorph and any binder, with regard to anode (B1-b) and the constituents present therein, namely the lithium absorbing material and any binder, with regard to separator (B1-c) and with regard to the components of the electrolyte composition (B1-d), namely solvent (B1-d1) and alkali metal salt (B1-d2), and the electrolyte composition (B1-d) itself, are identical to those described above in connection with the inventive battery.

During the operation of the above described electrochemical cell (B) a hydrostatic pressure in the range from 2 bar to 200 bar, preferably in the range from 2 bar to 100 bar, in particular in the range from 3 bar to 40 bar impacts on said cell (B). The operation comprises the operation steps of charging and discharging of said cell (B). In principle the applied hydrostatic pressure can be varied during different operation steps. Preferably the hydrostatic pressure is kept essentially constant during two consecutive operation steps, namely a charging step and a discharging step or vice versa. In the context of the present invention the term “an essentially constant hydrostatic pressure” means that the hydrostatic pressure does not vary more than 10%, preferably not more than 5%, based on the average hydrostatic pressure during the respective two operation steps wherein the measured pressure values at a certain temperature are recalculated to the corresponding pressure values at standard temperature (273.15 K).

In one embodiment of the present invention, the inventive process for operating an electrochemical cell (B) is characterized in that the operation comprises charging and discharging of the electrochemical cell (B).

In one embodiment of the present invention, the inventive process for operating an electrochemical cell (B) is characterized in that the hydrostatic pressure, which impacts on cell (B), is essentially kept constant during the two consecutive operation steps of charging and discharging.

Ways and means to expose cell (B) to a desired hydrostatic pressure have been described above.

The inventive process for operating an electrochemical cell (B) is particularly advantageous with respect to electrochemical cells (B) which exhibit a certain mass ratio between the total mass of sulfur comprised in cathode (B1-a) and the total mass of electrolyte compositions (B1-d) of assembly (B1). While the use of large amounts of electrolyte reduces the energy density of assembly (B1) the reduction of the total amount of electrolyte is usually limited due to the necessary retention of ion mobility between anode and cathode. The inventive process for operating an electrochemical cell (B) allows the reduction of the total amount of electrolyte relative to the total amount of sulfur compared with corresponding cells, which are exposed to atmospheric pressure, while retaining cycle life and coulombic efficiency of the cell with the higher energy density.

In one embodiment of the present invention, the inventive process for operating an electrochemical cell (B) is characterized in that the mass ratio of the total mass of sulfur comprised in cathode (B1-a) to the total mass of electrolyte composition (B1-d) of assembly (B1) is in the range from 0.05 to 1, preferably 0.1 to 0.7, in particular 0.33 to 0.5.

The invention is illustrated by the examples which follow but do not restrict the invention.

Figures in percent are each based on % by weight, unless explicitly stated otherwise.

### I. Cathode Preparation

For the preparation of the cathode slurry, 2.98 g sulfur (Alfa Aesar, 99.5%), 0.98 g carbon black (Printex® XE2, BET 1056 m²/g, Orion Engineered Carbons), 0.98 g carbon black (Vulcan® XC72, BET 230 m²/g, Cabot Corporation), 4.09 g poly(vinylalcohol)-solution (6 wt.-% in water, Selvol® 425, Sekisui) were mixed with subsequent addition of water and isopropanol to form a slurry. The resulting mixture was coated onto a primed aluminum foil (according to example 1 of US2010/0291442 A1) using doctor blade technique and dried in vacuum at 40° C. for 16 h. The sulfur loading of the final electrode was 2.0 g sulfur/cm². The standard composition of the final dry cathode amounted to approximately 55% sulfur, 40% carbon and 5% binder.

### II. Electrolyte and Cell Assembling

The electrolyte used was a mixture of 44 wt % 1,3-dioxolane, 44 wt % 1,2-dimethoxyethane, 8 wt % lithium bis(fluorosulfonyl)imide, 4 wt % lithium nitrate, on top of that another 1 wt % guanidinium nitrate was added. Cell-assembly of pouch type cells was performed in a dry room by stacking cathode, a polyolefin separator (Celgard 2325) and lithium foil (50 μm, Rockwood Lithium). After transfer of the assembly in a pouch-bag the cells were filled with electrolyte and immediately vacuum sealed. The amount of electrolyte was calculated from the desired ratio of active mass (sulfur) to the electrolyte.

### III. Electrochemical Testing

Discharge/charge measurements were performed in a potential range between 1.7 V and 2.5 V vs Li/Li+ and with an initial discharge rate of C/50 and subsequent rates of C/8 for charging and C/5 for discharging using MACCOR (Tulsa, Okla.), Astrol (Oberrohrdorf, Switzerland) or Basytec (Asselfingen, Germany) battery cyclers. The C-rate was calculated on the basis of the sulfur mass loading.

For cycling experiments under uniaxial pressure test cells were placed in a pressure rigs adjusted to apply a uniaxial pressure of 10 kg/cm² normal to the electrode surfaces. Experiments both with uniaxial and without pressure were carried out in a climate chamber at 25° C.

For cycling experiments under hydrostatic pressure, test-cells were placed in an autoclave which was equipped with connections to provide electrical contact to anode and cathode and the battery cycler. After placing the cell in the autoclave and connection to the electrochemical test equipment the autoclave was put under the desired pressure using inert gases (Ar, N₂).

TABLE 1
Effect of electrolyte-to-sulfur ratio and pressure on discharge capacity
and cycle life

| | discharge capacity (mAh/g_{Sulfur}) | | | | | | | |
|---|---|---|---|---|---|---|---|---|
| Ratio | 1st | 20th | 50th | 100th | 150th | 200th | 300th | |
| electrolyte/sulfur | cycle | cycle | cycle | cycle | cycle | cycle | cycle | |
| 7:1 | 1330.2 | 1128.5 | 1081.5 | 846.7 | Failed | Failed | Failed | No pressure |
| 3:1 | 1242.2 | 1107.4 | 1061.3 | 908.2 | Failed | Failed | Failed | Uniaxial |
| | | | | | | | | pressure |
| | | | | | | | | (10 kg/cm²) |
| 7:1 | 1241.2 | 1073.9 | 994.2 | 936.9 | Failed | Failed | Failed | Uniaxial |
| | | | | | | | | pressure |
| | | | | | | | | (10 kg/cm²) |
| 20:1 | 1025.2 | 866.4 | 878.3 | 813.2 | 768.4 | 697.7 | 627.4 | Uniaxial |
| | | | | | | | | pressure |
| | | | | | | | | (10 kg/cm²) |
| 7:1 | 1300.0 | 1092.3 | 1053.6 | 980.1 | 926.5 | 902.3 | 734.3 | Hydrostatic |
| | | | | | | | | pressure |
| | | | | | | | | (10 bar) |

Cells with electrolyte to sulfur ratios of 7:1 and 3:1 show stable discharge capacity up to 1000 mAh/g for the first 50 cycles when applying no or uniaxial pressure (normal to the electrode surface), however, the energy density is lower due to excess electrolyte. An increased fading of the discharge capacity is observed for the subsequent cycles which results in cell failure before the 150^{th} cycle. By increasing the electrolyte to sulfur ratio to 20:1 the fading rate is reduced which results into elongated cycle life at much lower overall discharge capacities and much lower energy density, even when applying an uniaxial pressure. Much higher discharge capacities and longer cycle life can be obtained when applying pressure in a hydrostatic fashion, even at electrolyte to sulfur ratio as low as 7:1. Thus, the introduction of hydrostatic pressure combined with lower electrolyte amount (7:1) in contrast to uniaxial pressure results in longer cycle life comparable to electrolyte to sulfur ratio of 20:1 but with much higher capacities.

1. A battery comprising
(A) a pressure vessel (A), and
(B) inside of the pressure vessel (A) at least one electrochemical cell (B), comprising
(B1) an assembly (B1), comprising
(B1-a) at least one cathode (B1-a) comprising at least one electroactive sulfur-containing material,
(B1-b) at least one anode (B1-b),
(B1-c) at least one separator (B1-c), and
(B1-d) at least one electrolyte composition (B1-d) comprising
(B1-d1) at least one solvent (B1-d1), and
(B1-d2) at least one alkali metal salt (B1-d2), and
(B2) optionally a case (B2) housing the assembly (B1),
wherein the pressure vessel (A) can be filled or is filled with a pressure medium (C) in order to generate a pressure in the range from 2 bar to 200 bar inside of said pressure vessel.

2. The battery according to claim 1, wherein pressure vessel (A) comprises or comprised an inlet and an outlet, through which pressure medium (C) can be filled into said pressure vessel (A) or drained off.

3. The battery according to claim 1 to 2, wherein the pressure medium (C) is a gaseous or liquid, electrically non-conducting compound.

4. The battery according to any of claims 1 to 3, wherein pressure vessel (A) and/or case (B2) tightly surround assembly (B1).

5. The battery according to any of claims 1 to 4, wherein case (B2) is made of a flexible material.

6. The battery according to any of claims 1 to 5, wherein case (B2) is sealed.

7. The battery according to any of claims 1 to 6, wherein the electroactive sulfur-containing material of cathode (B1-a) is elemental sulfur.

8. The battery according to any of claims 1 to 7, wherein anode (B1-b) comprises lithium.

9. The battery according to any of claims 1 to 8, wherein the solvent (B1-d1) is liquid at 40° C. and is selected from polymers, cyclic or noncyclic ethers, noncyclic or cyclic acetals, noncyclic or cyclic sulfones, noncyclic or cyclic sulfoamides and cyclic or noncyclic organic carbonates.

10. The battery according to any of claims 1 to 9, wherein the alkali metal salt (B1-d2) is a lithium salt.

11. The battery according to any of claims 1 to 10, wherein the mass ratio of the total mass of sulfur comprised in cathode (B1-a) to the total mass of electrolyte composition (B1-d) of assembly (B1) is in the range from 0.05 to 1.

12. A device comprising at least one battery according to any of claims 1 to 11.

13. Process for operating an electrochemical cell (B), comprising
(B1) an assembly (B1), comprising
(B1-a) at least one cathode (B1-a) comprising at least one electroactive sulfur-containing material,
(B1-b) at least one anode (B1-b),
(B1-c) at least one separator (B1-c), and
(B1-d) at least one electrolyte composition (B1-d) comprising
(B1-d1) at least one solvent (B1-d1), and
(B1-d2) at least one alkali metal salt (B1-d2), and
(B2) optionally a case (B2) housing the assembly (B1),
wherein the electrochemical cell (B) is exposed to a hydrostatic pressure in the range from 2 bar to 200 bar.

14. The process according to claim 13, wherein the operation comprises charging and discharging of the electrochemical cell (B).

15. The process according to claim 13 or 14, wherein the mass ratio of the total mass of sulfur comprised in cathode (B1-a) to the total mass of electrolyte composition (B1-d) of assembly (B1) is in the range from 0.05 to 1.
